(19) United States
(12) Patent Application Publication
(10) Pub. No.: US 2006/0192962 A1
(43) Pub. Date: Aug. 31, 2006

(54) Three-dimensional image display apparatus

(76) Inventor: Yujin Choi, Ansan (KR)

Correspondence Address: STITES & HARBISON PLLC, 1199 NORTH FAIRFAX STREET, SUITE 900, ALEXANDRIA, VA, 22314, US

(21) Appl. No.: 11/357,425

(22) Filed: Feb. 21, 2006

Related U.S. Application Data
(63) Continuation-in-part of application No. PCT/KR04/01995, filed on Aug. 9, 2004.

(30) Foreign Application Priority Data
Aug. 18, 2003 (KR) 10-2003-0057027

(51) Int. Cl. G01J 4/00

(52) U.S. Cl. 356/369

(57) ABSTRACT

The present invention provides a three-dimensional image display apparatus, including a first phase retardation plate including first and second polarized light regions in which retarder materials are oriented in different optical axis directions, wherein the first phase retardation plate retards light output from a polarized light display panel, and a second phase retardation plate including third and fourth polarized light regions in which retarder materials are oriented in different optical axis directions, wherein the second phase retardation plate retards incident light from the first phase retardation plate by a predetermined phase on a polarized-light-region basis. Therefore, light can be transferred to a viewer as accurate linear polarized light without regard to wavelength. Accordingly, a viewer can see a clear three-dimensional image using the polarized light glasses.

### CROSS REFERENCE TO RELATED APPLICATIONS

This application is a continuation-in-part of International Application No. PCT/KR2004/001995, filed Aug. 9, 2004 (which is hereby incorporated by reference).

### BACKGROUND OF THE INVENTION

1. Field of the Invention

The present invention relates to a three-dimensional image display apparatus, and more particularly, to a three-dimensional image display apparatus that can display a clear image.

2. Background of the Related Art

In general, the principle of displaying a three-dimensional image is based on the use of stereoscopic disparity incurred by the parallax of the left and right eyes. That is, different two-dimensional image information is formed on the right and left eyes due to the parallax that appears with the right and left eyes being spaced by about 65 mm. Right and left images are transferred to the brain and then combined. Therefore, a three-dimensional image can be recognized by the eyes.

The three-dimensional image display apparatus includes stereoscopic glasses, a parallax barrier screen, a lenticular screen, a holographic display and so on. The stereoscopic glasses are the most popular one since it can provide lots of viewers with a stereoscopic image at the same time and has a low manufacturing cost. The stereoscopic glasses include methods using anaglyph glasses, polarized glasses, LCD shutter glasses, etc.

The three-dimensional image LCD disclosed in Korean Patent Laid-Open Publication No. 2002-71541 includes a light-emitting region in which a first polarized light region and a second polarized light region of a micro unit, which have different polarization characteristics, are defined. The difference between the polarization characteristics of the first and second polarized light regions originates from a difference in the twist angle of a polymer liquid crystal film having a chiral dopant.

In the three-dimensional image LCD disclosed in Korean Patent Laid-Open Publication No. 2002-71541, red, green and blue lights are delayed with different phase differences, while passing the phase difference layer, and thus have different polarized light states. The polarized light glasses do not fully shut light with different polarized light states and therefore does not shut light other than wavelengths of a polarized light state that can be shut is not fully shut. Therefore, images by light other than a specific wavelength in the images for the right and left eyes are not completely shut by the right and left polarized light glasses, respectively, and are seen at one lens with them being overlapped with each other. Due to this, when viewing a three-dimensional images, a viewer can see a faint ghost image without seeing a clear three-dimensional image.

### SUMMARY OF THE INVENTION

Accordingly, the present invention has been made to solve the above problems occurring in the prior art, and it is an object of the present invention to provide a three-dimensional image display apparatus, including a first phase retardation plate including first and second polarized light regions in which retarder materials are oriented in different optical axis directions, wherein the first phase retardation plate retards light output from a polarized light display panel, and a second phase retardation plate including third and fourth polarized light regions in which retarder materials are oriented in different optical axis directions, wherein the second phase retardation plate retards incident light from the first phase retardation plate by a predetermined phase on a polarized-light-region basis.

In the three-dimensional image display apparatus according to the present invention, light of a green light, which has passed the first and second phase retardation plates is accurately modulated from a linear polarized light to a linear polarized light. A red or blue wavelength that is not properly modulated by the first phase retardation plate is compensated for by the second phase retardation plate so that it can become almost linear polarized light. Therefore, light can be transferred to a viewer as accurate linear polarized light without regard to wavelength. Accordingly, a viewer can see a clear three-dimensional image using the polarized light glasses.

### BRIEF DESCRIPTION OF THE DRAWINGS

Further objects and advantages of the invention can be more fully understood from the following detailed description taken in conjunction with the accompanying drawings in which:

FIG. 1 schematically shows a three-dimensional image display apparatus according to an embodiment of the present invention.

FIG. 2 schematically shows a three-dimensional image display apparatus according to an alternative embodiment of the present invention.

### DESCRIPTION OF THE PREFERRED EMBODIMENT

The present invention will now be described in detail in connection with preferred embodiments with reference to the accompanying drawings.

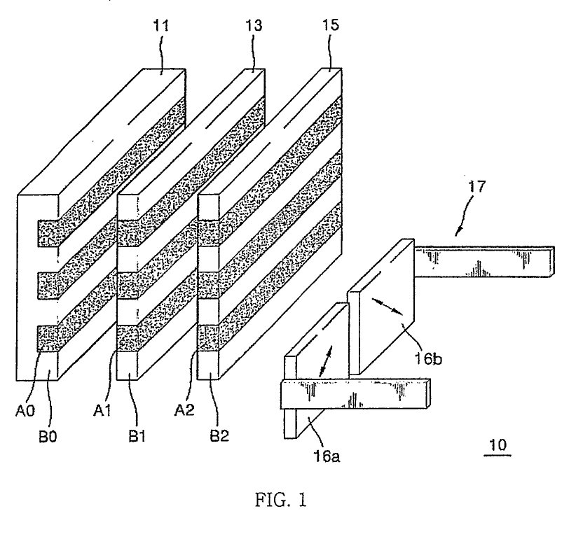

FIG. 1 schematically shows a three-dimensional image display apparatus 10 according to an embodiment of the present invention. The image is generated by a polarization display panel 11 having a first area A0 and a second area B0. This image is viewed using polarization glasses 17 having a left lens 16a and a right lens 16b.

Referring to FIG. 1, the three-dimensional image display apparatus 10 according to a first embodiment of the present invention includes a first phase retardation plate 13 that retards light output from a polarized light display panel 11 by a predetermined phase, and a second phase retardation plate 15 that retards light output from the first phase retardation plate 13 by a predetermined phase.

A first polarized light region A1 of the first phase retardation plate 13 receives light from first area A0 and includes a retarder material whose optical axis is oriented with it being shifted by about 22.5° from a polarized light direction. A third polarized light region A2 of the second phase retardation plate 15 receives light from first polarized light region A1 and includes a retarder material whose optical axis is oriented with it being shifted by about 67.5° (=22.5°×3) from light output from the polarized light from first area A0 of display panel 11.

Light output from the first polarized light region A1 has its phase delayed while passing through the first and third polarized light regions A1, A2 of the first and second phase retardation plates 13, 15. A polarized light direction of light that is finally output from the third polarized light region A2 is shifted about 90° from a polarized light direction of light that is output from the first polarized light region A1. At this time, it is preferred that an amount of phase retardation of the first and third polarized light regions A1, A2 is a half the green wavelength band.

Second and fourth polarized light regions B1, B2 of the first and second phase retardation plates 13, 15 includes a retarder material whose optical axis is oriented in the same direction as that of the output light from the polarized light display panel 11. Therefore, the second and fourth polarized light regions B1, B2 of the first and second phase retardation plates 13, 15 allow the output light from the polarized light of second area B0 of display panel 11 to pass through them without change.

As a result, the polarized light direction of light output from the third polarized light region A2 of the second phase retardation plate 15 and the polarized light direction of light output from the fourth polarized light region B2 of the second phase retardation plate make an angle of 90 degrees. This light is thus viewed through lenses 16a and 16b of glasses 17.

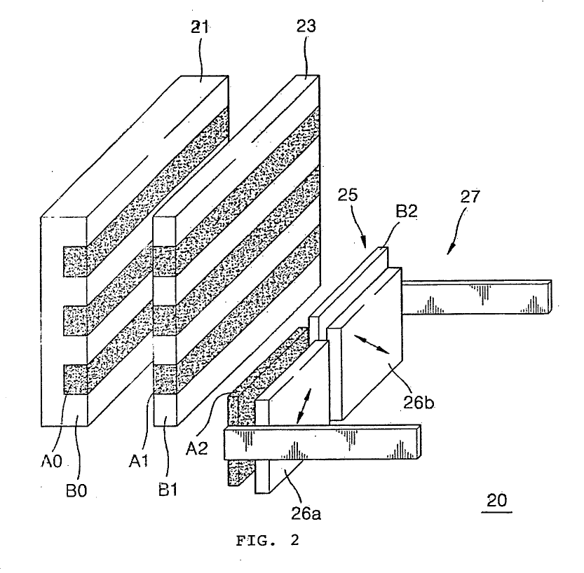

As another embodiment, there is depicted in FIG. 2 an optical axis direction of the first polarized light region A1 of the first phase retardation plate 23 and an optical axis direction of the fourth polarized light region B2 of the second phase retardation plate 25 which can be orthogonal to each other and which can have the same phase retardation amount. Alternatively, an optical axis direction of the second polarized light region B1 of the first phase retardation plate 23 and an optical axis direction of the third polarized light region A2 of the second phase retardation plate 25 can be vertical to each other and can have the same phase retardation amount. At this time, it is preferred that an amount of phase retardation of the first and third polarized light regions A1, A2 is ¼ of the green wavelength band.

As described above, the three-dimensional image display apparatus 10 according to the present invention includes the first and second phase retardation plates 23, 25. Therefore, light of a wavelength band, which is not properly modulated by the first phase retardation plate 23, is compensated through the second phase retardation plate 25. Accordingly, the present invention is advantageous in that it can improve the sharpness of an image recognized by the left and right eyes through lenses 26a and 26b of glasses 27.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A three-dimensional image display apparatus, comprising:
a first phase retardation plate including first and second polarized light regions in which retarder materials are oriented in different optical axis directions, wherein the first phase retardation plate retards light output from a polarized light display panel; and
a second phase retardation plate including third and fourth polarized light regions in which retarder materials are oriented in different optical axis directions, wherein the second phase retardation plate retards incident light from the first phase retardation plate by a predetermined phase on a polarized-light-region basis.

2. The three-dimensional image display apparatus as claimed in claim 1, wherein the first and second phase retardation plates are disposed in the polarization display panel.

3. The three-dimensional image display apparatus as claimed in claim 1, wherein the first and second phase retardation plates delay a phase as much as a half a green wavelength band.

4. The three-dimensional image display apparatus as claimed in claim 2, wherein the first phase retardation plate includes the first polarized light region in which the retarder material is oriented so that the retarder material has an optical axis shifted from a polarized light direction of the output light of the polarized light display panel to the extent that an angle between the polarized light direction of the output light of the polarized light display panel and a polarized light direction of output light of the third polarized light region of the second phase retardation plate is quadrisected.

5. The three-dimensional image display apparatus as claimed in claim 4, wherein the second phase retardation plate includes the third polarized light region in which the retarder material is oriented so that the retarder material has an optical axis shifted from the polarized light direction of the output light of the polarized light display panel to the extent that an angle between the polarized light direction of the output light of the polarized light display panel and a polarized light direction of output light of the third polarized light region of the second phase retardation plate is trisected.

6. The three-dimensional image display apparatus as claimed in claim 4, wherein the first phase retardation plate includes the second polarized light region in which the retardation material whose optical axis is parallel to the polarized light direction of the output light of the polarized light display panel is oriented.

7. The three-dimensional image display apparatus as claimed in claim 6, wherein the second phase retardation plate includes a fourth polarized light region in which a retardation material whose optical axis is parallel to the polarized light direction of the output light of the polarized light display panel is oriented.

8. The three-dimensional image display apparatus as claimed in claim 7, wherein the first phase retardation plate includes a first polarized light region in which a retardation material whose optical axis is shifted about 22.5° from the polarized light direction of the output light of the polarized light display panel is oriented.

9. The three-dimensional image display apparatus as claimed in claim 8, wherein the second phase retardation plate includes a third polarized light region in which a retardation material whose optical axis is shifted about 67.5° from the polarized light direction of the output light of the polarized light display panel is oriented.

10. The three-dimensional image display apparatus as claimed in claim 1, wherein an optical axis direction of the first polarized light region of the first phase retardation plate is vertical to that of the fourth polarized light region of the second phase retardation plate, and the first polarized light region of the first phase retardation plate and the fourth polarized light region of the second phase retardation plate have the same phase delay amount.

11. The three-dimensional image display apparatus as claimed in claim 10, wherein an optical axis direction of the second polarized light region of the first phase retardation plate is vertical to that of the third polarized light region of the second phase retardation plate, and the second polarized light region of the first phase retardation plate and the third polarized light region of the second phase retardation plate have the same phase delay amount.

12. The three-dimensional image display apparatus as claimed in claim 10, wherein the phase delay amount of the first and second phase retardation plates is ¼ of the green wavelength band.

13. The three-dimensional image display apparatus as claimed in claim 10, wherein the first phase retardation plate includes a first polarized light region in which a retardation material whose optical axis is shifted about 45° from the polarized light direction of the output light of the polarized light display panel is oriented, and a second polarized light region in which a retardation material whose optical axis is shifted about 135° from the polarized light direction of the output light of the polarized light display panel is oriented.

14. The three-dimensional image display apparatus as claimed in claim 1, wherein an optical axis direction of the first polarized light region of the first phase retardation plate is parallel to that of the fourth polarized light region of the second phase retardation plate, and the first polarized light region of the first phase retardation plate and the fourth polarized light region of the second phase retardation plate have the same phase delay amount.

15. The three-dimensional image display apparatus as claimed in claim 14, wherein an optical axis direction of the second polarized light region of the first phase retardation plate is orthogonal to that of the third polarized light region of the second phase retardation plate, and the second polarized light region of the first phase retardation plate and the third polarized light region of the second phase retardation plate have the same phase delay amount.
